(19) United States
(12) Patent Application Publication
(10) Pub. No.: US 2012/0204704 A1
(43) Pub. Date: Aug. 16, 2012

(54) ELECTRONIC DRUM KIT AND MODULE FOR A TABLET COMPUTING DEVICE

(75) Inventors: Brian R. Shim, Providence, RI (US); Daniel I. Radin, New York, NY (US)

(73) Assignee: ALESIS, L.P., Cumberland, RI (US)

(21) Appl. No.: 13/396,236

(22) Filed: Feb. 14, 2012

Related U.S. Application Data
(60) Provisional application No. 61/442,882, filed on Feb. 15, 2011.

(51) Int. Cl. G10H 7/00; G10H 3/00

(52) U.S. Cl. 84/645; 84/723

(57) ABSTRACT

An electronic drum kit module and drum kit using the same is disclosed. The module includes a body having a cradle configured and arranged to hold a tablet computing device. A number of trigger inputs are on the body and configured and arranged to receive trigger cables from a number of electronic instruments. A microprocessor in the body is configured and arranged to receive trigger signals from the trigger inputs and transmit a message to the tablet computing device corresponding to the electronic instrument that generated the trigger signal.

### CROSS-REFERENCE TO RELATED APPLICATION

The present patent document claims priority to earlier filed U.S. Provisional Patent Application Ser. No. 61/442,882, filed on Feb. 15, 2011, the entire contents of which are incorporated herein by reference.

### BACKGROUND OF THE INVENTION

1. Field of the Invention

The present patent document is directed generally to electronic percussion instruments and more particularly to an electronic drum kit and module for a tablet computing device.

2. Background of the Related Art

The advantages of electronic drum kits over acoustic kits are well known in the art. Such advantages include the ability to play a wide variety of drum sounds, the ability to play with reduced or very minimal acoustic noise, and more compact drum pad setup. Electronic drum kits include a number of drum pads and often cymbals. The electronic drum pads or cymbals usually include a piezo electric device inside the drum pad or cymbal that detects a physical strike against a drum pad or cymbal and generates an electronic signal in response. The electronic drum kits further include a drum trigger module that includes inputs for detecting physical strikes against one or more drum pads or cymbals and generates an electronic drum tone representative of the strike.

Prior art drum modules suffer from a number of disadvantages. In particular, prior art drum modules have limited numbers of percussion sounds, the quality of the prerecorded sounds is often poor, the digital signal processing capability lacks fidelity and features and user interface if often confusing and difficult to use. Although high-end electronic drum kits exist with improved features, these high-end systems cost many thousands of dollars, which is prohibitively expensive for most drummers.

Accordingly, there is a need in the industry for an inexpensive electronic drum kit that includes high-end features only found on deluxe and highly expensive systems.

### SUMMARY OF THE INVENTION

The present invention solves the problems of the prior are by providing an improved number of sounds, higher quality of sounds, enhanced digital signal processing power, and an enhanced user interface at a lower cost by interfacing with the user's existing tablet computing device, such as the Apple iPad. In this way, the expensive sample storage memory, digital signal processor, and display are offloaded to the user's tablet computing device, which has more memory and processing power than even the most expensive special-purpose drum module. Because tablet computing device also include a high-resolution, full-color touch screen, the musician has a greatly enhanced user interface that is superior to the user interface on prior art drum modules.

### BRIEF DESCRIPTION OF THE DRAWINGS

These and other features, aspects, and advantages of the present invention will become better understood with reference to the following description, appended claims, and accompanying drawings where:

FIG. 1 is a perspective view of an electronic drum kit showing the electronic drum module of the present invention;

FIG. 2 is a top view of the electronic drum module of the present invention showing a tablet computing device docked therein;

FIG. 3 is a left side view of the electronic drum module of the present invention;

FIG. 4 is a rear view of the electronic drum module of the present invention;

FIG. 5 is a right side view of the electronic drum module of the present invention;

FIG. 6 is a schematic view of an electronic drum module of the present invention; and

FIG. 7 is a schematic view of an alternative embodiment of the electronic drum module of the present invention.

### DESCRIPTION OF THE PREFERRED EMBODIMENT

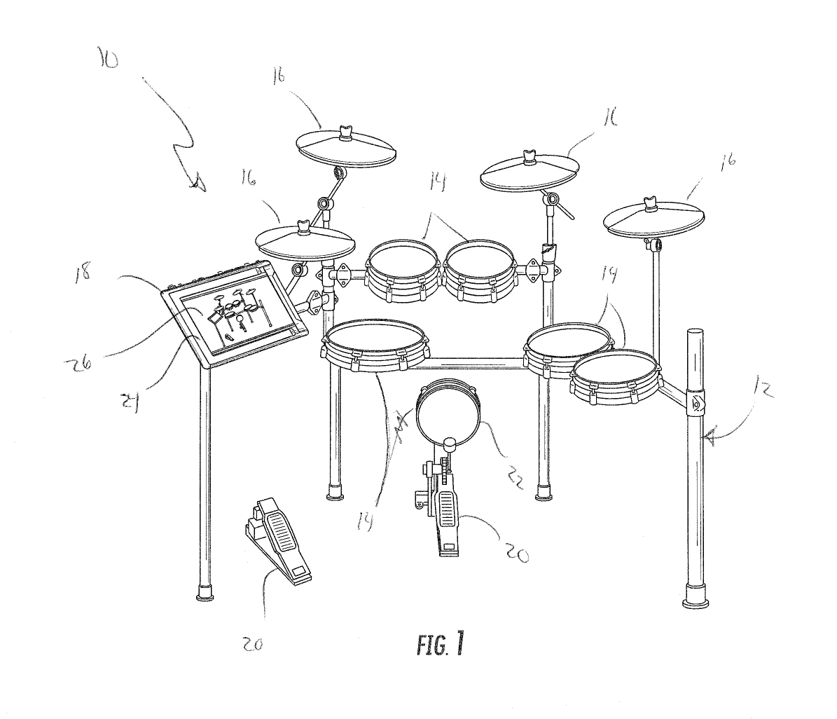

Referring now to FIG. 1, an electronic drum kit is shown generally at 10. The electronic drum kit 10 includes a drum stand 12, a number of electronic drum pads 14 and electronic cymbals 16 secured to the drum stand 12 and an electronic drum module 18. Foot pedals 20 may also be included for simulated high-hat cymbals and to kick a bass (or kick) drum 22. The drum pads 14 may be configured to simulate acoustic kick, snare and tom-tom drums. Electronic drums 14 and electronic cymbals 16 may be referred to generally as electronic instruments.

The electronic drum module 18 of the present invention includes a body 23 with a cradle 24 configured and arranged to hold a tablet computing device 26. The drum module 18 further includes a number of inputs, preferably located on a rear panel 30 of the drum module 18, configured to receive a number of trigger cables from drum pads 14 and electronic cymbals 16 of an electronic drum kit 10, which will be described in more detail below.

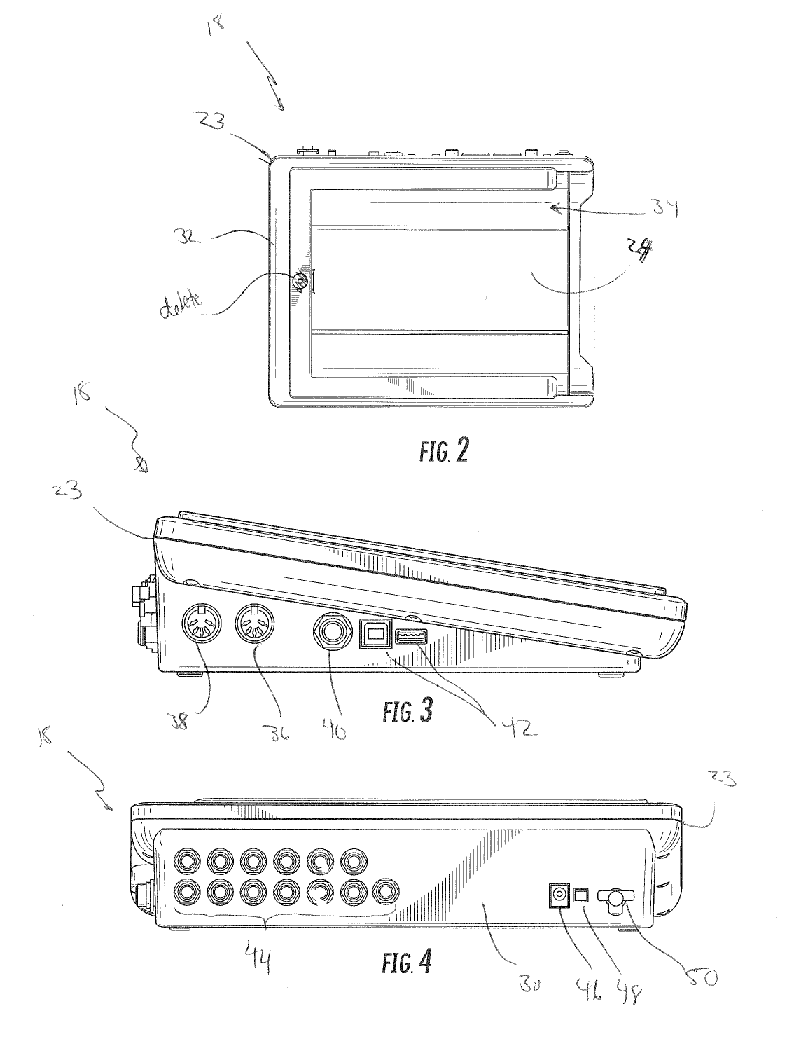

Referring to FIG. 2, the electronic drum module 18 includes a front face 32 cradle 24 with a slot 34 configured to receive a tablet computing device 26. The cradle 24 is preferably configured to hold the tablet computing device 26 in a landscape orientation to maximize the width of the screen, which musicians generally prefer. However, the slot 34 may also be oriented upwards to permit the tablet computing device 26 to be positioned in a portrait orientation for musicians that prefer that mode of operation.

Referring to FIG. 3, a left side of the electronic drum module 18 is shown. The electronic drum module 18 may further include MIDI input port 36 to permit additional electronic instruments, such as a keyboard or electric guitar for instance, to be connected to the electronic drum module 18 of the present invention. Also a MIDI output port 38 may be included to permit the MIDI control data from the electronic drum module 18 to be transmitted to a personal computer for further processing. The electronic drum module 18 may also include a connector 40 to receive a trigger cable from a foot switch 20, which is often configured to simulate a high-hat cymbal or kick drum. The foot switch connector 40 is often an ¼″ jack, but may be another style of connector. The electronic drum module 18 may also include one or more universal serial bus (“USB”) ports 42 to permit the electronic drum module 18 to be connected to a personal computer as well or other external devices, such as flash drives and external hard drives. The USB ports 42 may be of any type known in the art, such as Type A and Type B ports illustrated in FIG. 3.

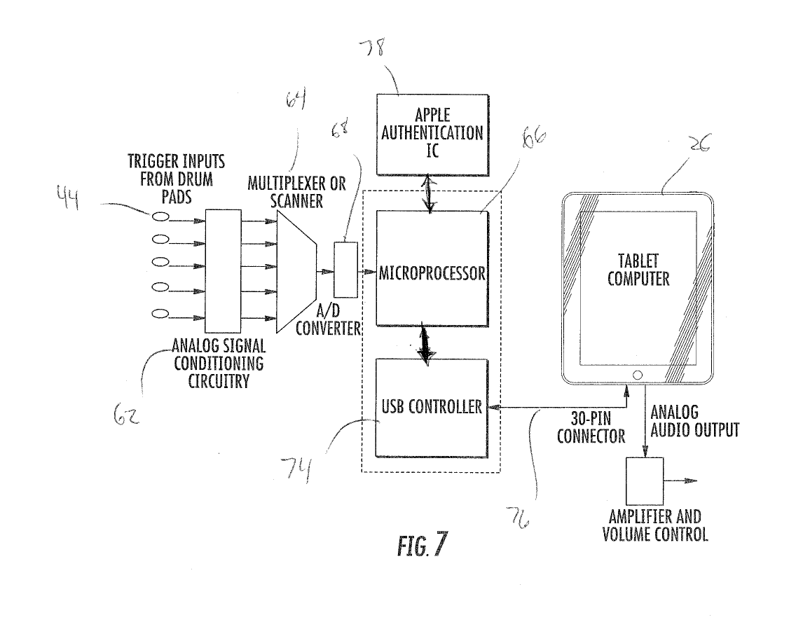

Referring now to FIG. 4, a rear panel 30 of the electronic drum module 18 of the present invention is shown generally. Specifically, the electronic drum module 18 includes a number of trigger inputs 44, which are preferably implemented with ¼″ audio style connectors that are connected via trigger cables to the electronic instruments. Alternatively, a mass multi-pin connection may be used, such as a DB25 connector. Trigger signals received by the trigger inputs 44 undergo analog processing (such as amplification, filtering, etc.) which will be further described below in conjunction with FIGS. 6 and 7. Also included on the rear panel 30 is a power input connector 46 to supply power to the electronic drum module 18 and a power switch 48 to turn the electronic drum module 18 on and off. The power supply may provide auxiliary power and charging to the tablet computing device 26. Alternatively, the electronic drum module 18 may also be powered by batteries. A cable restraint 50 may also be provided to protect the trigger cables of the electronic instruments.

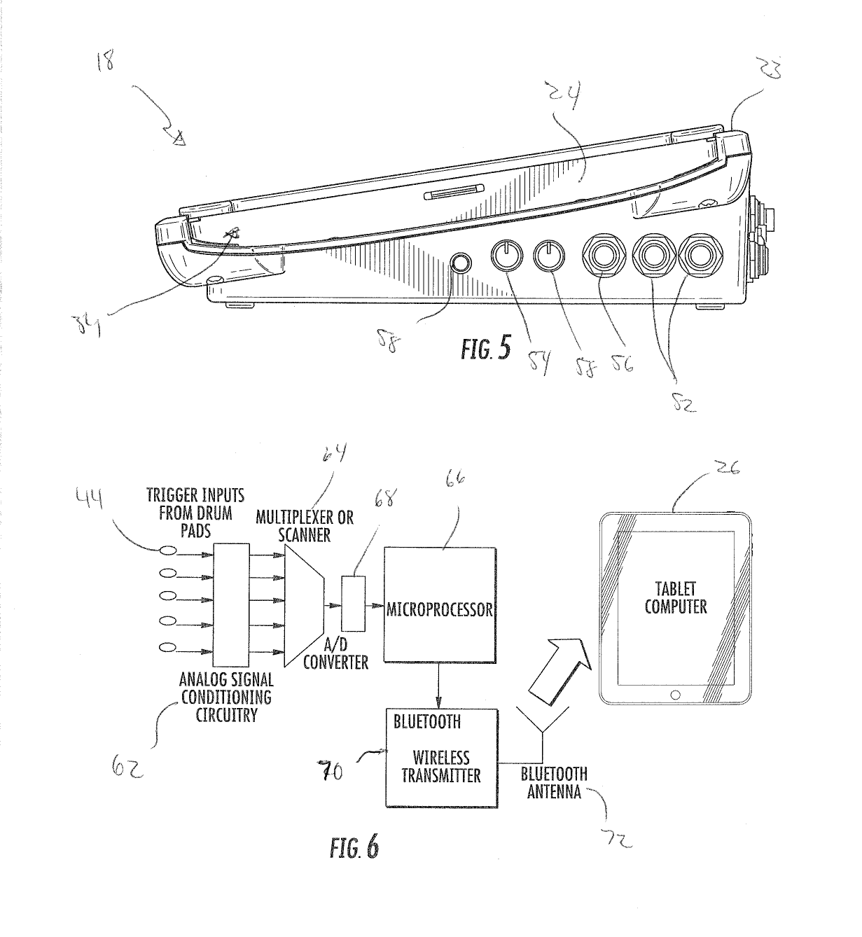

Referring to FIG. 5, a right side of the electronic drum module 18 of the present invention is shown. The electronic drum module 18 may include one or more main audio output ports, such as left and right RCA audio output jacks 52. XLR jacks may also be used. A main volume knob 54 controls the output volume of the main audio output ports 52. Also included is a separate head phone jack 56. The head phone jack 56 may be a configured as a ¼″ audio jack or a smaller, ⅛″ audio jack. The head phone jack 56 also includes a head phone volume knob 58 to allow for the volume of the head phone jack 56 to be separately adjusted from the main audio output ports 52. A line input jack 58 is also provided to permit additional analog audio, such as from a microphone, to be captured simultaneously with the musician's playing of the electronic drum kit 10.

Turning now to FIG. 6, when a musician strikes an electronic instrument, the electronic instrument transmits a trigger signal through the electronic instrument's trigger cable. The trigger cables are connected to the trigger inputs 44 on the electronic drum module 18. Trigger signals received by the trigger inputs 44 undergo analog processing 62, such as amplification and filtering, prior to being read by a digital scanner or multiplexer 64. The electronic drum module 18 further includes a microprocessor 66, which reads each of the trigger inputs 44, either through the use of the multiplexer, or by the scanner 64. The value of each trigger input 44 as determined by the multiplexer or scanner 64 is read through an analog-to-digital converter 68, which can be either a separate IC or built into the microprocessor 66 itself.

The microprocessor 66 sends a message to a wireless transmitter, such as a Bluetooth transmitter 70, corresponding to the electronic instrument that was hit and any parameters, such as velocity. The communication protocol can either be custom or use an existing protocol, such as Bluetooth Keyboard protocol in the case where a Bluetooth transmitter is used. For example, various number keys could be assigned to specific electronic instruments, and letters assigned to velocity of the strike. The wireless transmitter includes an antenna 72, which transmits these signals to the tablet computing device 26.

On the tablet computing device 26, a software program receives and interprets the messages as strikes on the electronic instruments and plays a preselected audio sample at the designated velocity. The audio sample is transmitted by the tablet computing device 26 to the electronic drum module 18, which amplifies and plays the audio sample through the head phone jack 56 and the main audio output jacks 52.

Referring now to FIG. 7, an alternative embodiment of the operation of the electronic drum module 18 is shown. In the alternative embodiment communication with the tablet computing device 26 is accomplished through wired, serial communication with the tablet computing device 26 instead of using a wireless transmitter 70. Like the first embodiment shown above in FIG. 6, trigger signals received by the trigger inputs 44 of the alternative embodiment undergo analog processing 62, such as amplification and filtering, prior to being read by a digital scanner or multiplexer 64. The alternative embodiment of the electronic drum module 18 also includes a microprocessor 66, which reads each of the trigger inputs 44, either through the use of the multiplexer, or by a scanner 64. The value of each trigger input 44 as determined by the multiplexer or scanner 64 is read through an analog-to-digital converter 68, which can be either a separate integrated circuit or built into the microprocessor 66 itself.

The microprocessor 66 sends a message to a USB controller 74, which is connected to the tablet computing device through a wired connection 76. To enable this communication in an Apple brand device, the microprocessor 66 must first authenticate the electronic drum module 18 with the Apple brand device by sending an authentication message to the Apple brand device through the USB controller 74 from an Apple authentication circuit 78. In other brand tablet computing devices 26, this authentication step may not be necessary and the authentication step may be omitted, simplifying the electronic drum module 18 of the present invention.

Once the wired communication to the tablet computing device 26 is established, the microprocessor 66 sends messages through the wired connection 76 via the USB controller 74 corresponding to the electronic instrument that was hit and any parameters, such as velocity. The message protocol that may be used to transmit electronic instrument strike and velocity data is arbitrary. For instance, MIDI USB communication protocol is preferable because the protocol is compatible with a large number of MIDI applications. However, a proprietary method of encoding the message may also be used.

On the tablet computing device 26, a software program, or application, receives and interprets the messages as strikes on the electronic instruments and plays a preselected audio sample at the designated velocity. The audio sample is transmitted by the tablet computing device 26 to the electronic drum module 18, which amplifies and plays the audio sample through the head phone jack 56 and the main audio output jacks 52.

The functions of the microprocessor 66 and the USB controller 74 may be combined into a single integrated circuit if it has sufficient speed to process the trigger inputs 44 in real-time. For example, the C8051F345 microprocessor could be used to do both functions. Another alternative is the ST Micro STM32 microprocessor.

Therefore, it can be seen that the present invention provides a unique solution to the problem of providing an inexpensive electronic drum kit that includes high-end features only found on deluxe and highly expensive systems by using an electronic drum module. Specifically, the electronic drum kit and module of the present invention provides for interconnection with a tablet computing device to access the computing power of the tablet computing device to perform advanced audio processing.

It would be appreciated by those skilled in the art that various changes and modifications can be made to the illustrated embodiments without departing from the spirit of the present invention. All such modifications and changes are intended to be within the scope of the present invention.

What is claimed is:

1. An electronic drum kit module, comprising:
a body having a cradle configured and arranged to hold a tablet computing device;
a plurality of trigger inputs on the body configured and arranged to receive trigger cables from a plurality of electronic instruments; and
a microprocessor in the body configured and arranged to receive trigger signals from the trigger inputs and transmit a message to the tablet computing device corresponding to the electronic instrument that generated the trigger signal.

2. The module of claim 1, wherein the electronic instruments comprise drum pads and electronic cymbals.

3. The module of claim 1, wherein the message is transmitted wirelessly.

4. The module of claim 3, wherein the message is transmitted wirelessly via Bluetooth keyboard protocol.

5. The module of claim 1, wherein the message is transmitted via a wired connection.

6. The module of claim 5, wherein the message is transmitted through a wired universal serial bus connection.

7. The module of claim 1, wherein the trigger inputs are configured as ¼″ audio style connectors.

8. The module of claim 1, further comprising analog signal conditioning circuitry configured and arranged to condition the trigger signals from the trigger inputs.

9. The module of claim 1, further comprising a MIDI input.

10. The module of claim 1, wherein the message further includes velocity data.

11. An electronic drum kit, comprising:
a stand;
a plurality of electronic instruments support by the stand; and
an electronic drum kit module having a body having a cradle configured and arranged to hold a tablet computing device, a plurality of trigger inputs on the body configured and arranged to receive trigger cables from the plurality of electronic instruments, and a microprocessor in the body configured and arranged to receive trigger signals from the trigger inputs and transmit a message to the tablet computing device corresponding to the electronic instrument that generated the trigger signal.

12. The kit of claim 11, wherein the electronic instruments comprise drum pads and electronic cymbals.

13. The kit of claim 11, wherein the message is transmitted wirelessly.

14. The kit of claim 13, wherein the message is transmitted wirelessly via Bluetooth keyboard protocol.

15. The kit of claim 11, wherein the message is transmitted via a wired connection.

16. The kit of claim 15, wherein the message is transmitted through a wired universal serial bus connection.

17. The kit of claim 11, wherein the trigger inputs are configured as ¼″ audio style connectors.

18. The kit of claim 11, further comprising analog signal conditioning circuitry configured and arranged to condition the trigger signals from the trigger inputs.

19. The kit of claim 11, further comprising a MIDI input.

20. The kit of claim 11, wherein the message further comprises velocity data.
